(19) United States
(12) Patent Application Publication
(10) Pub. No.: US 2015/0030976 A1
(43) Pub. Date: Jan. 29, 2015

(54) BLACK TONER FOR DEVELOPING LATENT ELECTROSTATIC IMAGE AND METHOD FOR PRODUCING THE SAME

(71) Applicants: Kei Yokokawa, Kanagawa (JP); Yasuaki Iwamoto, Shizuoka (JP); Takahiro Kadota, Shizuoka (JP)

(72) Inventors: Kei Yokokawa, Kanagawa (JP); Yasuaki Iwamoto, Shizuoka (JP); Takahiro Kadota, Shizuoka (JP)

(21) Appl. No.: 14/379,894

(22) PCT Filed: Feb. 28, 2013
(86) PCT No.: PCT/JP2013/056222

§ 371 Date: Aug. 20, 2014

(30) Foreign Application Priority Data
Mar. 15, 2012 (JP) 2012-059246

(51) Int. Cl. G03G 9/097; G03G 9/08

(52) U.S. Cl. CPC G03G 9/09766; G03G 9/0804
USPC 430/108.15; 430/109.1; 430/137.1

(57) ABSTRACT

A black toner for developing a latent electrostatic image, including: a toner base containing a pigment, a binder resin, a releasing agent, a compound containing fluorine and a compound containing sulfur; and an external additive, wherein the toner contains the external additive on a surface of the toner base, and wherein an amount of the fluorine in the toner base is 200 ppm by mass to 600 ppm by mass as measured by combustion-ion chromatography, and an amount of the sulfur in the toner base is 1,000 ppm by mass to 1,500 ppm by mass as measured by the combustion-ion chromatography.

### TECHNICAL FIELD

The present invention relates to a black toner for developing a latent electrostatic image and a method for producing the same.

### BACKGROUND ART

In, for example, electrophotographic apparatus and electrostatic recording apparatus, a toner is deposited on a latent electrostatic image formed on a photoconductor, and the resultant image is transferred onto a recording medium, and then fixed on the recording medium, whereby a toner image is formed. Also, full-color image formation is generally reproducing colors using four color toner of black, yellow, magenta and cyan. In full-color image formation, developing is performed on each of the colors, the resultant toner layers are superposed on top of one another on a recording medium, the composite image is heated and fixed at the same time to thereby obtain a full-color image.

However, users who often see printed matters have not yet satisfied the quality of images formed by full-color copiers. They have required such a higher image quality that meets high definition and high resolution comparable to pictures and prints. As has been known, in order for an electrophotographic image to have a higher image quality, it is advantageous to use a toner having a smaller particle diameter and a narrower particle size distribution.

Various attempts have been made on increase in image quality in the field of electrophotography. Among them, an increased number of researchers have recognized that it is remarkably effective to use smaller and more spherical toner. However, a toner having a smaller particle diameter is degraded in transferability and fixability, tending to form a poor image. Meanwhile, it is known that more spherical toner is improved in transferability (see PTL 1).

Under such circumstances, a high-speed process of image formation has also been demanded in the fields of color copiers and color printers. “Tandem manner” is effective for attaining a high-speed process of image formation (see, for example, PTL 2). “Tandem manner” is a manner in which images each formed by respective image forming units are transferred onto one recording medium conveyed on a transfer belt so that they are superposed thereon on top of one another, to thereby obtain a full-color image on the recording medium. A color image forming apparatus of tandem manner has advantageous features that it can use all kinds of recording paper and can form a high-quality full-color image at high speed. In particular, the feature of forming a full-color image at high speed is a specific feature that color image forming apparatus of another manner do not have.

Some toners have been attempted to have high-speed processability also while being formed into spherical particles for attaining high-quality images. High-speed proccesability requires more rapid fixability. So far, spherical toners with both good fixability and low-temperature fixability have not yet been realized. Toners experience severe conditions such as high-temperature, high-humidity environments and low-temperature, low-humidity environments when stored or transported after their production. Thus, they have been required to have such excellent storageability that involves no or quite less degradation in charging property, flowability, transferability and fixability without aggregation of toner particles during storage under various environments. However, there has not yet been found an effective measure to produce spherical toners that meet the above requirements.

In one known measure to increase chargeability of toners (especially, negatively chargeable toners), a fluorine-containing compound is incorporated into a toner as, for example, a charge controlling agent (see, for example, PTLs 3 and 4). In accordance with these techniques, the toner exhibits favorably environmental stable in chargeability since the difference in a charge amount by friction between under high-temperature, high-humidity environments and low-temperature, low-humidity environments. However, the toner is increased in fixing temperature, still requiring an effective measure to ensure low-temperature fixability and prevent hot offset in a trace amount.

Another attempt is to control an atomic mass ratio between fluorine and carbon present on the surfaces of toner particles (see PTL 5). However, it does not take fixability into consideration, and the toner is degraded in fixability, which is not desired.

An attempt to increase fixability is to similarly control an atomic mass ratio between fluorine and carbon present on the surfaces of toner particles (see PTL 6). Although the toner is improved in fixability, the toner cannot sufficiently be suppressed in filming on a photoconductor due to external additives exfoliated therefrom.

### CITATION LIST

### Patent Literature

PTL 1: Japanese Patent Application Laid-Open (JP-A) No. 09-258474
PTL 2: JP-A No. 05-341617
PTL 3: Japanese Patent (JP-B) No. 2942588
PTL 4: JP-B No. 3102797
PTL 5: JP-B No. 3407521
PTL 6: JP-B No. 4070702

### SUMMARY OF INVENTION

### Technical Problem

The present invention aims to solve the above existing problems and achieve the following object. That is, an object of the present invention is to provide a black toner for developing a latent electrostatic image that is sufficiently high in charge rising property, that is excellent in charging stability over time, that involves less filming on a photoconductor due to an external additive exfoliated from the toner even after several tens thousands images have been printed out, and that is excellent in fixing property.

### Solution to Problem

Means for solving the above problems are as follows.

That is, a black toner for developing a latent electrostatic image of the present invention includes: a toner base containing a pigment, a binder resin, a releasing agent, a compound containing fluorine and a compound containing sulfur, wherein an amount of the fluorine in the toner base is 200 ppm by mass to 600 ppm by mass as measured by combustion-ion chromatography, and an amount of the sulfur in the toner base is 1,000 ppm by mass to 1,500 ppm by mass as measured by the combustion-ion chromatography.

### Advantageous Effects of Invention

The present invention can provide a black toner for developing a latent electrostatic image that is sufficiently high in charge rising property, that is excellent in charging stability over time, that involves less filming on a photoconductor due to an external additive exfoliated from the toner even after several tens thousands images have been printed out, and that is excellent in fixing property. The toner of the present invention can solve the above-existing problems and achieve the above object.

### DESCRIPTION OF EMBODIMENTS

### (Black Toner for Developing a Latent Electrostatic Image)

A black toner for developing a latent electrostatic image of the present invention (hereinafter may be referred to simply as “toner”) contains at least a toner base and an external additive, where the toner base contains the external additive on a surface thereof.

### <Toner Base>

The toner base contains at least a pigment, a binder resin, a releasing agent, a compound containing fluorine (i.e., a fluorine-containing compound) and a compound containing sulfur (i.e., a sulfur-containing compound); and, if necessary, further contains other ingredients.

In combustion-ion chromatography, an amount of the fluorine in the toner base is 200 ppm by mass to 600 ppm by mass, and an amount of the sulfur in the toner base is 1,000 ppm by mass to 1,500 ppm by mass.

Here, the above toner base means toner particles the surfaces of which have not yet been provided with an external additive. Also, the mass of fluorine may be abbreviated as “mass of F” and the mass of sulfur may be abbreviated as “mass of S.”

The present inventors found that controlling the mass of fluorine contributing to chargeability and the mass of sulfur serving as an electrical leakage substance to fall within the above respective specific ranges could form a black toner for developing a latent electrostatic image that is satisfactory in all of charge rising property, charging stability over time, suppression of filming on a photoconductor, and fixing property. In addition, when the fluorine-containing compound is dispersed in water containing alcohol and then attached (bonded) on the surfaces of a toner for developing a latent electrostatic image, the resultant toner is in a more desired state since the effects of the fluorine can further be obtained.

In the present invention, it is particularly important to achieve desired toner's charge rising property simultaneously with desired photoconductor durability by suppressing filming due to exfoliated external additives. Charge rising property is an index of how fast and uniformly the toner can have a desired charge amount. Better charge rising property leads to saving electricity, which is important. Photoconductor's filming due to exfoliated external additives means a state where toner ingredients are thinly deposited on, for example, a wide range of the photoconductor surface. It mainly occurs because the external additive trapped in a gap between the photoconductor surface and a surface of a member coming into contact with the photoconductor surface (e.g., a cleaning blade) melts by friction with the photoconductor and adheres to the photoconductor.

A mechanism with which the present invention can solve the above problems is now under analysis, but the following can be stated in view of several analysis data.

The present invention is particularly effective to a negatively chargeable toner, which is produced by dispersing in an aqueous medium an organic phase dispersion liquid containing a toner composition, containing a prepolymer, dissolved in an organic solvent, followed by elongating reaction and/or crosslinking reaction. Such a toner is not sufficient in charging stability, but as in the present invention, use of a compound containing fluorine having high electronegativity can impart higher negative chargeability to the toner.

Meanwhile, sulfur contained in a sulfur-containing compound such as a sulfur-containing anionic surfactant remaining on the surface of the toner base is an electrical leakage substance. However, according to a finding obtained by the present inventors, sulfur increases the toner base in terms of adhesiveness of external additives to the toner base, reducing filming on the photoconductor by the external additive exfoliated from the toner.

As described above, use of the fluorine-containing compound improves charge rising property. Although reasons for this are not clear, when some of the sulfur-containing compound are present on the toner base surface in a large amount, adhesiveness between the toner base and the external additives such as silica increases, to thereby improve photoconductor's filming due to the external additive exfoliated from the toner base.

Next will be described the masses of fluorine and sulfur accounting for the toner base.

Tables 1-1 and 1-2 each present effects of the mass of F or S accounting for the toner base on quality of a toner. When the amount of F accounting for the toner base is small, charge rising property becomes insufficient but minimum fixing temperature becomes low. When the amount of F accounting for the toner base is large, charge rising property is good but minimum fixing temperature becomes high.

When the amount of S accounting for the toner base is small, the releasing rate of the external additive (which causes filming on the photoconductor) increases, but charging stability over time (which means here that the resultant toner can have stable charge amount even after long-term use) become good since the amount of S serving as an electrical leakage substance is small. When the amount of S accounting for the toner base is large, the releasing rate of the external additive (which causes filming on the photoconductor) decreases, but charging stability over time become insufficient since the amount of S serving as an electrical leakage substance is large.

TABLE 1-1

| | Measurements by combustion-ion | |
|---|---|---|
| Mass of F accounting for | chromatography | |
| mass of toner base | Small | Large |
| Charge rising property | Poor | Good |
| Minimum fixing temperature | Good | Poor |
| Suppression of filming on | Unchanged | Unchanged |
| photoconductor | | |
| Charging stability over time | Unchanged | Unchanged |

TABLE 1-2

| | Measurements by combustion-ion | |
|---|---|---|
| Mass of S accounting for | chromatography | |
| mass of toner base | Small | Large |
| Charge rising property | Unchanged | Unchanged |
| Minimum fixing temperature | Unchanged | Unchanged |
| Suppression of filming on | Poor | Good |
| photoconductor | | |
| Charging stability over time | Good | Poor |

### <<Fluorine-Containing Compound>>

The fluorine-containing compound may be an organic or inorganic compound, but is preferably any of the following compounds (1) to (14) in terms of charge rising property. These compound function also as a charge controlling agent, and all assume white or pale yellow. Among them, preferred are N,N,N-trimethyl-[3-(4-perfluorononenyloxybenzamide)propyl]ammonium iodide expressed by formula (1) and N,N,N-triethyl-[3-(4-perfluorononenyloxybenzamide)pentyl]ammonium iodide expressed by formula (3), and particularly preferred is N,N,N-trimethyl-[3 (4 perfluorononenyloxybenzamide)propyl]ammonium iodide expressed by formula (1) in terms of charge rising property.

This compound may be used in combination with another fluorine-containing compound.

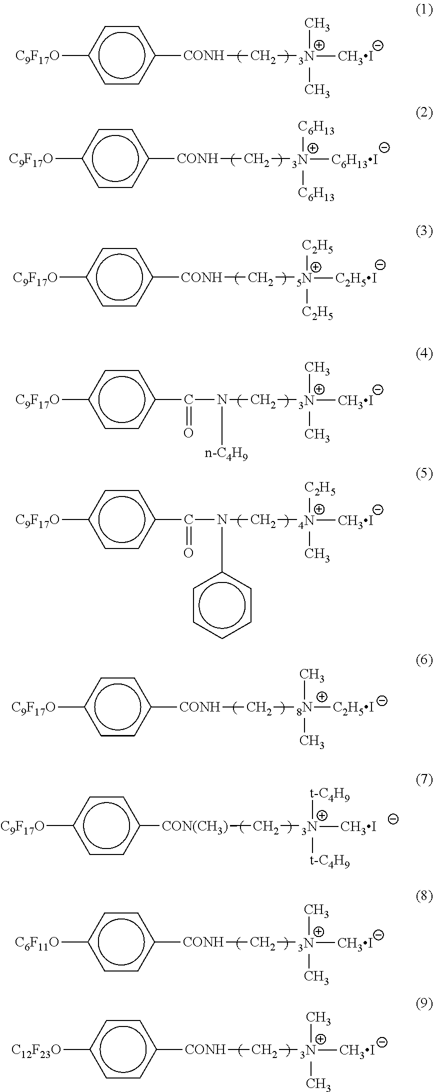

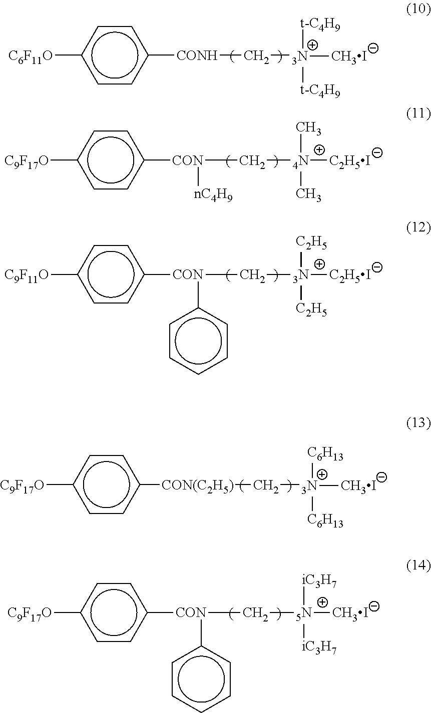

The effects obtained by the addition of the fluorine-containing compound are not particularly influenced by the purity, pH, thermal decomposition temperature, and properties as fine powder of the fluorine-containing compound.

The amount of the fluorine-containing compound added is preferably 0.01% by mass to 0.3% by mass, more preferably 0.05% by mass to 0.2% by mass, relative to the solid content of a filtration cake containing toner particles to be surface-treated.

When it is less than 0.01% by mass, the effects of the present invention cannot be obtained sufficiently. When it is more than 0.3% by mass, the toner involves unfavorable phenomena such as fixing failures, which is not preferred.

In one method for providing the toner particles with the fluorine-containing compound, an aqueous liquid containing the fluorine-containing compound dispersed therein (water containing a surfactant is preferred) is used to attach (or ionically bind) the fluorine-containing compound to the surfaces of the toner particles, followed by removing the solvent and drying, to thereby form a toner base. When alcohol is mixed with the aqueous liquid containing the fluorine-containing compound dispersed therein (water containing a surfactant is preferred) in an amount of 5% by mass to 80% by mass, preferably 10% by mass to 50% by mass, relative to the amount of the aqueous liquid, the fluorine-containing compound is further improved in dispersibility and uniformly attached on the surfaces of the toner base, which is preferred since charging uniformity between toner particles is improved.

A method for providing the toner particles with the fluorine-containing compound may be a method in which the fluorine-containing compound is attached or immobilized on the surfaces of the toner base. Specific examples thereof include: attaching or immobilizing the fluorine-containing compound on the surfaces of the toner base with mechanical shearing force; immobilizing the fluorine-containing compound on the surfaces of the toner base with a combination of mixing and heating; and immobilizing the fluorine-containing compound on the surfaces of the toner base with a combination of mixing and mechanical impact.

Alternatively, the fluorine-containing compound may be immobilized on the surfaces of the toner base via chemical bonds (e.g., a covalent bond, a hydrogen bond and an ion bond) between fine powder of the fluorine-containing compound and other materials contained in the toner.

### <<Sulfur-Containing Compound>>

The sulfur-containing compound is not particularly limited and may be appropriately selected depending on the intended purpose, but is preferably an anionic surfactant containing sulfur (i.e., a sulfur-containing anionic surfactant). The sulfur-containing anionic surfactant is used as a dispersing agent for emulsifying and dispersing, in the aqueous medium, the organic phase dispersion liquid containing the toner composition dispersed therein.

Examples of the sulfur-containing anionic surfactant include: alkyl diphenyl ether disulfonic acid salts such as diammonium dodecyl diphenyl ether disulfonate, sodium dodecyl diphenyl ether disulfonate, calcium dodecyl diphenyl ether disulfonate and sodium alkyl diphenyl ether disulfonate; alkylbenzenesulfonic acid salts such as sodium dodecylbenzene sulfonate and ammonium dodecylbenzene sulfonate; and sodium lauryl sulfate. These may be used alone or in combination.

The amount of the sulfur-containing compound in the aqueous medium is preferably 4% by mass to 10% by mass as a solid content concentration. When it is less than 4% by mass, the external additive is exfoliated from the toner base, and filming-preventive effects may drop. When it is more than 10% by mass, the sulfur-containing compound serves as an electrical leakage substance on the toner surfaces, potentially degrading charging functions.

### [Masses of Fluorine Atom and Sulfur Atom Accounting for Mass of Toner Base]

The masses of the fluorine atom and the sulfur atom accounting for the mass of toner base can be determined by combustion-ion chromatography. In the present invention, the following apparatus and conditions are adopted.

(i) Sample combusting apparatus: AQF-100, product of Mitsubishi Chemical Analytech Co., Ltd.
(ii) Conditions: combustion temperature: inlet temp. 900° C., outlet temp. 1,000° C., Gas: Ar/O₂: 200 mL/min, O₂: 400 mL/min, Ar: 150 mL/min, absorption liquid: hydrogen peroxide 90 ppm by mass 3 mL, sample loop: 100 μL
(iii) Ion chromatograph: ICS-1500, product of DIONEX Co., Ltd.
(iv) Conditions: anion analytical column: IonPac AS12A, guard column: IonPac AG12A, dissolution liquid: 2.7 mM Na₂CO₃/0.3 mM NaHCO₃, column temp.: 35° C.

### (Pigment)

In the present invention, a black pigment is used as the pigment. The pigment may be appropriately selected from known ones, and examples thereof include carbon black, iron black and a mixture thereof. The pigment may be used in combination with complementary colorants which are pigments or dyes such as metal-free phthalocyanin blue, phthalocyanin blue, fast sky blue, indanthrene blue (RS and BC), indigo, ultramarine, iron blue and anthraquinon blue.

The amount of the colorant is preferably 1% by mass to 15% by mass, more preferably 3% by mass to 10% by mass, relative to the total amount of the toner.

The pigment may be mixed with a resin to form a masterbatch. Examples of the resin which is used for producing a masterbatch or which is kneaded together with a masterbatch include the above-described modified or unmodified polyesters; styrene polymers and substituted products thereof (e.g., polystyrenes, poly-p-chlorostyrenes and polyvinyltoluenes); styrene copolymers (e.g., styrene-p-chlorostyrene copolymers, styrene-propylene copolymers, styrene-vinyltoluene copolymers, styrene-vinylnaphthalene copolymers, styrene-methyl acrylate copolymers, styrene-ethyl acrylate copolymers, styrene-butyl acrylate copolymers, styrene-octyl acrylate copolymers, styrene-methyl methacrylate copolymers, styrene-ethyl methacrylate copolymers, styrene-butyl methacrylate copolymers, styrene-methyl x-chloro methacrylate copolymers, styrene-acrylonitrile copolymers, styrene-vinyl methyl ketone copolymers, styrene-butadiene copolymers, styrene-isoprene copolymers, styrene-acrylonitrile-indene copolymers, styrene-maleic acid copolymers and styrene-maleic acid ester copolymers); polymethyl methacrylates; polybutyl methacrylates; polyvinyl chlorides; polyvinyl acetates; polyethylenes; polypropylenes, polyesters; epoxy resins; epoxy polyol resins; polyurethanes; polyamides; polyvinyl butyrals; polyacrylic acid resins; rosin; modified rosin; terpene resins; aliphatic or alicyclic hydrocarbon resins; aromatic petroleum resins; chlorinated paraffins; and paraffin waxes. These may be used alone or in combination.

The masterbatch can be prepared by mixing/kneading the pigment with a resin for use in a masterbatch through application of high shearing force. Also, an organic solvent may be used for improving mixing between the pigment and the resin. Further, the flashing method, in which an aqueous paste containing a pigment is mixed/kneaded with a resin and an organic solvent and then the pigment is transferred to the resin to remove water and the organic solvent, is preferably used, since a wet cake of the pigment can be directly used (i.e., no drying is required to be performed). In this mixing/kneading, a high-shearing disperser (e.g., three-roll mill) is preferably used.

### <<Binder Resin>>

The binder resin is not particularly limited and may be appropriately selected depending on the intended purpose. Examples thereof include modified polyesters and unmodified polyesters.

### —Modified Polyester—

Examples of the modified polyester include: an isocyanate group-containing polyester prepolymer (A); and a urea-modified polyester (i) obtained through crosslinking and/or elongating reaction between the above isocyanate group-containing polyester prepolymer and a crosslinking agent and/or an elongating agent such as the below-described amines (B). Examples of the isocyanate group-containing polyester prepolymer (A) include a product obtained by reacting polyisocyanate (3) with a polyester which is a polycondensate between polyol (1) and polycarboxylic acid (2) and contains an active hydrogen group.

Examples of the active hydrogen group the above polyester has include hydroxyl groups (i.e., an alcoholic hydroxyl group and a phenolic hydroxyl group), an amino group, a carboxyl group and a mercapto group, with an alcoholic hydroxyl group being preferred.

Examples of the polyol (1) include diols (1-1) and trihydric or higher polyols (1-2), with the diols (1-1) alone or a mixture containing the diols (1-1) and a small amount of the trihydric or higher polyols (1-2) being preferred.

Examples of the diols (1-1) include alkylene glycols (e.g., ethylene glycol, 1,2-propylene glycol, 1,3-propylene glycol, 1,4-butanediol and 1,6-hexanediol); alkylene ether glycols (e.g., diethylene glycol, triethylene glycol, dipropylene glycol, polyethylene glycol, polypropylene glycol and polytetramethylene ether glycol); alicyclic diols (e.g., 1,4-cyclohexanedimethanol and hydrogenated bisphenol A); bisphenols (e.g., bisphenol A, bisphenol F and bisphenol S); adducts of the above-listed alicyclic diols with alkylene oxides (e.g., ethylene oxide, propylene oxide and butylene oxide); and adducts of the above-listed bisphenols with alkylene oxides (e.g., ethylene oxide, propylene oxide and butylene oxide).

Of these, preferred are C2 to C12 alkylene glycols and alkylene oxide adducts of bisphenols. Particularly preferred are combinations of alkylene oxide adducts of bisphenols and C2 to C12 alkylene glycols.

Examples of the trihydric or higher polyols (1-2) include trihydric to octahydric or higher aliphatic polyalcohols (e.g., glycerin, trimethylolethane, trimethylolpropane, pentaerythritol and sorbitol); trihydric or higher phenols (e.g., trisphenol PA, phenol novolac and cresol novolac); and alkylene oxide adducts of the above trihydric or higher polyphenols.

Examples of the polycarboxylic acid (2) include dicarboxylic acids (2-1) and trivalent or higher polycarboxylic acids (2-2), with the dicarboxylic acids (2-1) alone or a mixture containing the dicarboxylic acids (2-1) and a small amount of the trivalent or higher polycarboxylic acids (2-2) being preferred.

Examples of the dicarboxylic acids (2-1) include alkylene dicarboxylic acids (e.g., succinic acid, adipic acid and sebacic acid); alkenylene dicarboxylic acids (e.g., maleic acid and fumaric acid); and aromatic dicarboxylic acids (e.g., phthalic acid, isophthalic acid, terephthalic acid and naphthalene dicarboxylic acid). Of these, preferred are C4 to C20 alkenylenedicarboxylic acids and C8 to C20 aromatic dicarboxylic acids.

Examples of the trivalent or higher polycarboxylic acids (2-2) include C9 to C20 aromatic polycarboxylic acids (e.g., trimellitic acid and pyromellitic acid). Note that, the trivalent or higher polycarboxylic acids (2-2) may be reacted with polyols (1) using acid anhydrides or lower alkyl esters (e.g., methyl ester, ethyl ester and isopropyl ester) of the above carboxylic acids.

The ratio between the polyol (1) and the polycarboxylic acid (2) is generally 2/1 to 1/1, preferably 1.5/1 to 1/1, more preferably 1.3/1 to 1.02/1, in terms of the equivalent ratio [OH]/[COOH] of the hydroxyl group [OH] to the carboxyl group [COOH].

Examples of the polyisocyanate (3) include aliphatic polyisocyanates (e.g., tetramethylene diisocyanate, hexamethylene diisocyanate and 2,6-diisocyanatomethylcaproate); alicyclic polyisocyanates (e.g., isophorone diisocyanate and cyclohexylmethane diisocyanate); aromatic diisocyanates (e.g., tolylene diisocyanate and diphenylmethane diisocyanate); aromatic-aliphatic diisocyanate (e.g., α,α,α′,α′-tetramethylxylylene diisocyanate); isocyanurates; products obtained by blocking the above polyisocyanates with phenol derivatives, oxime and caprolactam; and mixtures thereof.

The ratio of the polyisocyanate (3) to the polyester resin containing a hydroxyl group is generally 5/1 to 1/1, preferably 4/1 to 1.2/1, more preferably 2.5/1 to 1.5/1, in terms of the equivalent ratio [NCO]/[OH] of the isocyanate group [NCO] to the hydroxyl group [OH] of the polyester resin.

When the ratio [NCO]/[OH] exceeds 5, the formed toner is degraded in low-temperature fixing property. When the [NCO] is less than 1, the urea content of the modified polyester is lowered, and the formed toner is degraded in hot offset resistance.

The amount of the polyisocyanate (3) contained in the prepolymer (A) containing an isocyanate group at an end thereof is generally 0.5% by mass to 40% by mass, preferably 1% by mass to 30% by mass, more preferably 2% by mass to 20% by mass. When the amount thereof is less than 0.5% by mass, the formed toner is degraded in hot offset resistance, and also is difficult to have both desired heat resistant storage stability and desired low-temperature fixing property. Whereas when the amount thereof exceeds 40% by mass, the formed toner is degraded in low-temperature fixing property.

The number of isocyanate groups contained per molecule of the prepolymer (A) containing an isocyanate group is generally 1 or more on average, preferably 1.5 to 3 on average, more preferably 1.8 to 2.5 on average. When the number thereof is less than 1 per molecule, the modified polyester obtained through crosslinking and/or elongating is decreased in molecular weight and thus, the formed toner is degraded in hot offset resistance.

The binder resin may be produced in the following method, for example.

Specifically, the polyol (1) and the polycarboxylic acid (2) are heated to a temperature of 150° C. to 280° C. in the presence of a known esterification catalyst such as tetrabutoxy titanate or dibutyltin oxide. Subsequently, the formed water is removed under reduced pressure if necessary, to thereby obtain a polyester having a hydroxyl group. Thereafter, the thus-prepared polyester is reacted with the polyisocyanate (3) at a temperature of 40° C. to 140° C. to thereby obtain the prepolymer (A) containing an isocyanate group.

—Crosslinking Agent and/or Elongating Agent—

In the present invention, an amine may be used as the crosslinking agent and/or elongating agent.

Examples of the amine (B) include diamines (B1), trivalent or higher polyamines (B2), aminoalcohols (B3), aminomercaptans (B4), amino acids (B5) and amino-blocked compounds (B6) obtained by blocking the amino groups of (B1) to (B5).

Examples of the diamine (B1) include aromatic diamines (e.g., phenylene diamine, diethyltoluene diamine and 4,4′-diaminodiphenylmethane); alicyclic diamines (e.g., 4,4′-diamino-3,3′-dimethyldicyclohexylmethane, diaminecyclohexane and isophorondiamine); and aliphatic diamines (e.g., ethylenediamine, tetramethylenediamine and hexamethylenediamine).

Examples of the trivalent or higher polyamine (B2) include diethylenetriamine and triethylenetetramine.

Examples of the aminoalcohol (B3) include ethanolamine and hydroxyethylaniline.

Examples of the aminomercaptan (B4) include aminoethylmercaptan and aminopropylmercaptan.

Examples of the amino acid (B5) include aminopropionic acid and aminocaproic acid.

Examples of the amino-blocked compound (B6) obtained by blocking the amino groups of (B1) to (B5) include oxazolidine compounds and ketimine compounds derived from the amines (B1) to (B5) and ketones (e.g., acetone, methyl ethyl ketone and methyl isobutyl ketone).

Of these, preferred are diamines (B1) and mixtures containing diamines (B1) and a small amount of trivalent or higher polyamines (B2).

If necessary, a reaction terminator may be used to adjust the molecular weight of the modified polyester after completion of reaction. Examples of the reaction terminator include monoamines (e.g., diethylamine, dibutylamine, butylamine and laurylamine) and blocked products thereof (e.g., ketimine compounds).

The ratio of the amine (B) to the isocyanate group-containing prepolymer (A) is generally 1/2 to 2/1, preferably 1.5/1 to 1/1.5, more preferably 1.2/1 to 1/1.2, in terms of the equivalent ratio [NCO]/[NHx] of the isocyanate group [NCO] to the amino group [NHx] of the amine (B). When the ratio [NCO]/[NHx] exceeds 2 or less than ½, the urea-modified polyester (i) is decreased in molecular weight and thus, the formed toner is degraded in hot offset resistance.

### —Unmodified Polyester—

In the present invention, the modified polyester may be used alone, but an unmodified polyester is preferably contained as a binder resin component together with the modified polyester. When the unmodified modified polyester is used in combination, the formed toner is improved in low-temperature fixing property and glossiness when used in a full-color apparatus. Examples of the unmodified polyester include polycondensates between the polyols (1) and the polycarboxylic acids (2) similar to those for the polyester component in the modified polyester. Preferred examples thereof are similar to those for the modified polyester.

The modified polyester may be modified with a chemical bond other than a urea bond, such as a urethane bond. Being compatible at least partially between the modified polyester and the unmodified polyester is preferred from the viewpoint of low-temperature fixing property and hot offset resistance. Therefore, the modified polyester preferably has similar composition to that of the unmodified polyester.

When the modified polyester is used, the mass ratio of the modified polyester to the unmodified polyester is generally 5/95 to 75/25, preferably 10/90 to 25/75, more preferably 12/88 to 25/75, particularly preferably 12/88 to 22/78. When the mass ratio of the modified polyester is less than 5%, the formed toner is degraded in hot offset resistance, and also is difficult to have both desired heat resistant storage stability and desired low-temperature fixing property.

The peak molecular weight of the unmodified polyester is generally 1,000 to 30,000, preferably 1,500 to 10,000, more preferably 2,000 to 8,000. When the peak molecular weight thereof is lower than 1,000, the heat resistance storageability is degraded. Whereas when the peak molecular weight thereof is higher than 10,000, the low temperature fixability is degraded. The hydroxyl value of the unmodified polyester is preferably 5 or more, more preferably 10 to 120, particularly preferably 20 to 80. When the hydroxyl value thereof is less than 5, it may be difficult to attain both desired heat resistance storage stability and desired low temperature fixing property. The acid value of unmodified polyester) is generally 0.5 to 40, preferably 5 to 35 mgKOH/g. When the unmodified polyester has an acid value, the formed toner tends to be negatively charged. When the acid value and the hydroxyl value deviate from the above corresponding ranges, the formed toner is susceptible to environmental factors under high-temperature, high-humidity conditions or low-temperature, low-humidity conditions, easily causing degradation of images.

### <<Releasing Agent>>

The toner of the present invention contains a releasing agent such as wax together with the pigment and the binder resin.

The wax may be any known wax, and examples thereof include: polyolefin wax (e.g., polyethylene wax and polypropylene wax); long-chain hydrocarbons (e.g., paraffin wax and SASOLWAX); and carbonyl group-containing wax.

Of these, carbonyl group-containing wax is preferred.

Examples of the carbonyl group-containing wax include: polyalkanoic acid esters (e.g., carnauba wax, montan wax, trimethylolpropane tribehenate, pentaerythritol tetrabehenate, pentaerythritol diacetate dibehenate, and glycerin tribehenate, 1,18-octadecanediol distearate); polyalkanol esters (e.g., tristearyl trimellitate and distearyl maleate); polyalkanoic acid amides (e.g., ethylenediamine dibehenyl amide); polyalkylamides (e.g., trimellitic acid tristearyl amide); and dialkyl ketones (e.g., distearyl ketone). Of these, polyalkanoic acid esters are preferred.

The melting point of the wax is preferably 40° C. to 160° C., more preferably 50° C. to 120° C., still more preferably 60° C. to 90° C. Wax which is lower than 40° C. in melting point has an adverse effect on heat resistant storage stability, and wax which is higher than 160° C. in melting point is likely to cause cold offset when toner is fixed at low temperatures. The melt viscosity of the wax is preferably 5 cps to 1,000 cps, more preferably 10 cps to 100 cps, as a measurement obtained at a temperature higher than the melting point by 20° C. Wax which is higher than 1,000 cps in melt viscosity is not much effective in improving hot offset resistance and low-temperature fixing property.

The amount of the wax contained in the toner is preferably 0% by mass to 40% by mass, more preferably 3% by mass to 30% by mass.

### <<Other Ingredients>>

### <<<Charge Controlling Agent>>>

If necessary, the toner of the present invention may contain a charge controlling agent other than a fluorine-containing compound. The charge controlling agent may be any known charge controlling agent. Examples thereof include nigrosine dyes, triphenylmethane dyes, chrome-containing metal complex dyes, molybdic acid chelate pigments, rhodamine dyes, alkoxy amines, quaternary ammonium salts (including fluorine-modified quaternary ammonium salts), alkylamides, phosphorus, phosphorus compounds, tungsten, tungsten compounds, fluorine active agents, metal salts of salicylic acid, and metal salts of salicylic acid derivatives.

Specific examples of the charge controlling agent include nigrosine dye BONTRON 03, quaternary ammonium salt BONTRON P-51, metal-containing azo dye BONTRON S-34, oxynaphthoic acid-based metal complex E-82, salicylic acid-based metal complex E-84 and phenol condensate E-89 (these products are of ORIENT CHEMICAL INDUSTRIES CO., LTD), quaternary ammonium salt molybdenum complex TP-302 and TP-415 (these products are of Hodogaya Chemical Co., Ltd.), quaternary ammonium salt COPY CHARGE PSY VP 2038, triphenylmethane derivative COPY BLUE PR, quaternary ammonium salt COPY CHARGE NEG VP2036 and COPY CHARGE NX VP434 (these products are of Clariant Co., Ltd.), LRA-901 and boron complex LR-147 (these products are of Japan Carlit Co., Ltd.), copper phthalocyanine, perylene, quinacridone, azo pigments, and polymeric compounds having, as a functional group, a sulfonic acid group, a carboxyl group or a quaternary ammonium salt.

The amount of the charge controlling agent used is not flatly determined and is varied depending on the type of the binder resin used, on the presence or absence of an optionally used additive, and on the toner production method used including a dispersion method. The amount of the charge controlling agent used is preferably 0.1 parts by mass to 10 parts by mass, more preferably 0.2 parts by mass to 5 parts by mass, per 100 parts by mass of the binder resin. When the amount of the charge controlling agent is more than 10 parts by mass, the formed toner has too high chargeability, resulting in that the charge controlling agent exhibits reduced effects. As a result, the electrostatic attractive force increases between the developing roller and the toner, decreasing the fluidity of the toner and forming an image with reduced color density. The charge controlling agent may be melt-kneaded together with a masterbatch or a resin before dissolution or dispersion. Needless to say, the charge controlling agent may be dissolved in an organic solvent directly or at the time when other toner components are dispersed in an organic solvent. Furthermore, after the formation of the toner particles, the charge controlling agent may be fixed on the surfaces of the toner particles.

### <<<Fine Resin Particles>>>

If necessary, the toner of the present invention may contain fine resin particles. The fine resin particles used preferably have a glass transition temperature (Tg) of 40° C. to 100° C. and have a mass average molecular weight of 9,000 to 200,000. As described above, when the glass transition temperature (Tg) thereof is lower than 40° C. and/or the mass average molecular weight thereof is less than 9,000, the obtained toner is degraded in storage stability, so that blocking may occur during storage and in a developing unit. Whereas when the glass transition temperature (Tg) thereof is higher than 100° C. and/or the mass average molecular weight thereof is greater than 200,000, the fine resin particles impair adhesiveness to paper, so that the lowest fixing temperature may be increased.

The residual rate of the fine resin particles in the toner particles is preferably 0.5% by mass to 5.0% by mass. When the residual rate thereof is less than 0.5% by mass, the obtained toner is degraded in storage stability, so that blocking may occur during storage and in a developing unit. Whereas when it is more than 5.0% by mass, the fine resin particles prevent the wax from oozing out, so that the wax may not exhibit its releasing effects to cause offset. The residual rate of the fine resin particles can be measured as follows. Specifically, a substance derived from the fine resin particles rather than the toner particles is analyzed with a pyrolysis gas chromatograph mass analyzer, and a peak area of the substance is used to calculate the residual rate of the fine resin particles. A detector used is not particularly limited but is preferably a mass analyzer.

The fine resin particles are not particularly limited and may be any resin capable of forming an aqueous dispersion and may be a thermoplastic or thermosetting resin. Examples thereof include vinyl resins, polyurethane resins, epoxy resins, polyester resins, polyamide resins, polyimide resins, silicon-containing resin, phenol resins, melamine resins, urea resins, aniline resins, ionomer resins and polycarbonate resins. These may be used alone or in combination.

Among them, preferred are vinyl resins, polyurethane resins, epoxy resins, polyester resins and mixtures thereof, from the viewpoint of easily obtaining an aqueous dispersion of spherical fine resin particles.

The vinyl resin is a polymer produced through homopolymerization or copolymerization of vinyl monomers. Examples of the vinyl resin include styrene-(meth)acylate resins, styrene-butadiene copolymers, (meth)acrylic acid-acrylate polymers, styrene-acrylonitrile copolymers, styrene-maleic anhydride copolymers and styrene-(meth)acrylic acid copolymers.

### <External Additive>

The toner of the present invention contains an external additive to assist its flowability, developability and chargeability. Examples of the external additive include inorganic particles and polymer particles.

The external additive is, for example, inorganic particles and hydrophobized inorganic particles. The external additive preferably contains at least one kind of hydrophobized inorganic particles whose primary particles has an average particle diameter of 1 nm to 100 nm, preferably 5 nm to 70 nm. More preferably, the external additive contains at least one kind of hydrophobized inorganic particles whose primary particles has an average particle diameter of 5 nm to 20 nm and at least one kind of inorganic particles having an average particle diameter of 30 nm to 70 nm.

When the average particle diameter of the primary particles is less than 1 nm, such inorganic particles are embedded in each toner particle, and hardly exhibit their effects. When it is more than 100 nm, such inorganic particles unevenly damage the surface of a photoconductor, which is not preferred.

Also, the specific surface area of the external additive as measured by the BET method is preferably 20 m²/g to 500 m²/g.

The amount of the external additive used is preferably 0.1% by mass to 5% by mass, more preferably 0.3% by mass to 3% by mass, relative to the amount of the toner base particles.

Examples of the external additive include silica particles, hydrophobic silica, fatty acid metal salts (e.g., zinc stearate and aluminum stearate), metal oxides (e.g., titania, alumina, tin oxide and antimony oxide) and fluoropolymers.

Particularly suitable external additives include hydrophobized silica, titania, titanium oxide and alumina particles.

Examples of the silica particles include HDK H 2000, HDK H 2000/4, HDK H 2050EP, HVK21, HDK H 1303 (these products are of Clariant Co., Ltd.) and R972, R974, RX200, RY200, R202, R805, R812 (these products are of Nippon Aerosil Co., Ltd.). Examples of the titania particles include P-25 (product of Nippon Aerosil Co., Ltd.), STT-30, STT-65C-S (these products are of Titan Kogyo, Ltd.), TAF-140 (product of FUJI TITANIUM INDUSTRY CO., LTD.), MT-150W, MT-500B, MT-600B and MT-150A (these products are of TAYCA Co., Ltd.). Examples of the hydrophobized titanium oxide particles include T-805 (product of Nippon Aerosil Co., Ltd.), STT-30A, STT-65S-S (these products are of Titan Kogyo, Ltd.), TAF-500T, TAF-1500T (these products are of FUJI TITANIUM INDUSTRY CO., LTD.), MT-100S, MT-100T (these products are of TAYCA Co., Ltd.) and IT-S (product of ISHIHARA SANGYO KAISHA, LTD.).

The hydrophobized oxide particles (silica particles, titania particles and alumina particles) can be obtained by treating hydrophilic particles with a silane coupling agent such as methyltrimethoxysilane, methyltriethoxysilane or octyltrimethoxysilane.

Also, suitably used are inorganic particles and oxide particles treated with silicone oil (if necessary, through application of heat).

Examples of the silicone oil include dimethylsilicone oil, methylphenylsilicone oil, chlorophenyl silicone oil, methylhydrogen silicone oil, alkyl-modified silicone oil, fluorine-modified silicone oil, polyether-modified silicone oil, alcohol-modified silicone oil, amino-modified silicone oil, epoxy-modified silicone oil, epoxy•polyether-modified silicone oil, phenol-modified silicone oil, carboxy-modified silicone oil, mercapto-modified silicone oil, (meth)acryl-modified silicone oil and α-methylstyrene-modified silicone oil.

### <Other Ingredients>

### <<Cleanability Improving Agent>>

The cleanability improving agent is used in order for a developer remaining after transfer on a photoconductor and a primary transfer medium to be removed. Examples thereof include metal salts of fatty acids such as stearic acid (e.g., zinc stearate and calcium stearate), polymer particles formed by soap-free emulsification polymerization, such as polymethyl methacrylate particles and polystylene particles. The polymer particles preferably have a relatively narrow particle size distribution. It is preferable that the volume average particle diameter thereof be 0.01 μm to 1 μm.

### [Properties of Toner]

The glass transition temperature (Tg) of the toner of the present invention is preferably 40° C. to 70° C., more preferably 45° C. to 55° C. When the glass transition temperature is lower than 40° C., the toner is degraded in heat resistance storage stability. Whereas when it is higher than 70° C., the toner is insufficient in low-temperature fixing property. When a polyester resin crosslinked and/or elongated is used in combination, the toner is better in heat resistance storage stability than known polyester-based toners even when the glass transition temperature thereof is low.

As for the storage modulus of the toner of the present invention, the temperature (TG′) at which it is 10,000 dyn/cm², at a measurement frequency of 20 Hz, is preferably 100° C. or higher, more preferably 110° C. to 200° C. When the temperature (TG′) is lower than 100° C., there is a decrease in hot offset resistance.

As for the viscosity of the toner, the temperature (Ta) at which it is 1,000 poise, at a measurement frequency of 20 Hz, is preferably 180° C. or lower, more preferably 90° C. to 160° C. When the temperature (Tη) is higher than 180° C., there is a decrease in low-temperature fixing property.

Accordingly, it is preferable in terms of a balance between low-temperature fixing property and hot offset resistance that the TG′ is higher than the Tη. In other words, the difference (TG′−Tη) between TG′ and Tη is preferably 0° C. or greater. It is more preferably 10° C. or greater, particularly preferably 20° C. or greater. The upper limit of the difference between TG′ and Tη is not particularly limited. Also, it is preferable in terms of a balance between heat resistance storage stability and low-temperature fixing property that the difference between Tη and Tg is 0° C. to 100° C. It is more preferably 10° C. to 90° C., particularly preferably 20° C. to 80° C.

### (Method for Producing Black Toner for Developing a Latent Electrostatic Image)

The toner of the present invention can be produced by the following method, but methods employable in the present invention are not limited thereto.

### <Production of Toner in an Aqueous Medium>

A method of the present invention for producing a toner includes: dispersing, in an aqueous medium containing a sulfur-containing compound, an organic phase dispersion liquid containing a pigment, a binder resin and a releasing agent dispersed in an organic solvent, to thereby prepare a dispersion slurry; and providing a filtration cake obtained from the dispersion slurry with a fluorine-containing compound, to thereby prepare a toner base; and, if necessary, further includes other steps.

Fine resin particles are preferably added in advance to the aqueous medium in the present invention. The aqueous medium used may be water alone or a mixture of water and a water-miscible solvent. Examples of the water-miscible solvent include alcohols (e.g., methanol, isopropanol and ethylene glycol), dimethylformamide, tetrahydrofuran, cellosolves (e.g., methyl cellosolve), lower ketones (e.g., acetone and methyl ethyl ketone) and ethyl acetate.

The toner of the present invention is produced by dispersing, in an aqueous medium containing a sulfur-containing compound, an organic phase dispersion liquid containing a pigment, a binder resin and a releasing agent dispersed in an organic solvent; removing the organic solvent; and washing and drying the resultant product.

Dispersoids of the isocyanate group-containing prepolymer (A) may be reacted with the amine (B) in the aqueous medium, or previously produced urea-modified polyester (i) may be used.

Examples of a method for stably forming dispersoids of the urea-modified polyester (i) or the prepolymer (A) in the aqueous medium include a method in which a composition containing the urea-modified polyester (i), the prepolymer (A), and toner raw materials such as a complex of a resin and a pigment is added to the aqueous medium, where they are dispersed with shearing force.

The urea-modified polyester (i) or the prepolymer (A) may be mixed with the toner raw materials such as a releasing agent, a charge controlling agent and an unmodified polyester resin in the aqueous medium upon formation of dispersoids thereof. Preferably, the toner raw materials are previously mixed together, and the resultant mixture is added to and dispersed in the aqueous medium.

A method for the dispersing is not particularly limited. Known dispersers employing, for example, low-speed shearing, high-speed shearing, friction, high-pressure jetting and ultrasonic wave can be employed.

In order for dispersoids to have a particle diameter of 2 μm to 20 μm, a high-speed shearing disperser is preferably used. In use of the high-speed shearing disperser, the rotating speed is not particularly limited and is generally 1,000 rpm to 30,000 rpm, preferably 5,000 rpm to 20,000 rpm. Also, the dispersion time is not particularly limited and is generally 0.1 min to 5 min when a batch method is employed. The temperature during dispersion is generally 0° C. to 150° C. (under pressure), preferably 40° C. to 98° C. The temperature during dispersion is preferably higher since the viscosity of the dispersion formed of the urea-modified polyester (i) or the prepolymer (A) and the pigment-resin complex is low and the dispersing is easy to perform.

The amount of the aqueous medium used is generally 50 parts by mass to 300 parts by mass relative to 100 parts by mass of the toner composition containing the urea-modified polyester (i) and the prepolymer (A). When the amount of the aqueous medium is less than 50 parts by mass, the toner composition is poorly dispersed, so that toner particles having an intended particle diameter cannot be obtained. Meanwhile, use of the aqueous medium in an amount of more than 300 parts by mass is not economical. If necessary, a dispersing agent may be used. Use of the dispersing agent is preferred from the viewpoints of attaining a sharp particle size distribution and realizing a stable dispersion state.

In the step of synthesizing the urea-modified polyester (i) or the prepolymer (A), the amine (B) may be added to and reacted in the aqueous medium before the toner composition is dispersed therein. Alternatively, the amine (B) may be added to the aqueous medium after the toner composition has been dispersed therein, causing reaction from the interfaces between the formed particles. In this case, the urea-modified polyester (i) is formed preferentially on the surfaces of the toner particles, which can provide concentration gradient from the surface to the core of the particles.

A dispersing agent for emulsifying and dispersing, in the aqueous medium, the organic phase dispersion liquid in which the toner composition has been dispersed is preferably an anionic surfactant. Inorganic compound dispersoids or the following polymeric protective colloid can be used in combination with fine organic resin particles to stabilize dispersed liquid droplets.

The anionic surfactant is preferably a sulfur-containing anionic surfactant as the above sulfur-containing compound.

Examples of the polymeric protective colloid include homopolymers or copolymers of acids (e.g., acrylic acid, methacrylic acid, a-cyanoacrylic acid, a-cyanomethacrylic acid, itaconic acid, crotonic acid, fumaric acid, maleic acid and maleic anhydride); hydroxyl group-containing (meth)acrylic monomers (e.g., β-hydroxyethyl acrylate, β-hydroxyethyl methacrylate, β-hydroxypropyl acrylate, (3-hydroxypropyl methacrylate, y-hydroxypropyl acrylate, y-hydroxypropyl methacrylate, 3-chloro-2-hydroxypropyl acrylate, 3-chloro-2-hydroxypropyl methacrylate, diethylene glycol monoacrylic acid esters, diethylene glycol monomethacrylic acid esters, glycerin monoacrylic acid esters, glycerin monomethacrylic acid esters, N-methylolacrylamide and N-methylolmethacrylamide), vinyl alcohol and ethers thereof (e.g., vinyl methyl ether, vinyl ethyl ether and vinyl propyl ether), esters formed between vinyl alcohol and a carboxyl group-containing compound (e.g., vinyl acetate, vinyl propionate and vinyl butyrate); acrylamide, methacrylamide, diacetone acrylamide and methylol compounds thereof, acid chlorides (e.g., acrylic acid chloride and methacrylic acid chloride); and nitrogen-containing heterocyclic compounds (e.g., vinyl pyridine, vinyl pyrrolidone, vinyl imidazole and ethyleneimine). Further examples thereof include polyoxyethylene compounds (e.g., polyoxyethylene, polyoxypropylene, polyoxyethylene alkyl amines, polyoxypropylene alkyl amines, polyoxyethylene alkyl amides, polyoxypropylene alkyl amides, polyoxyethylene nonylphenyl ethers, polyoxyethylene laurylphenyl ethers, polyoxyethylene stearylphenyl esters and polyoxyethylene nonylphenyl esters); and celluloses (e.g., methyl cellulose, hydroxyethyl cellulose and hydroxypropyl cellulose).

Furthermore, in order to decrease the viscosity of the toner, there can be used a solvent in which the urea-modified polyester (i) or the prepolymer (A) can be dissolved. Use of the solvent is preferred from the viewpoint of attaining a sharp particle size distribution. The solvent used is preferably a volatile solvent having a boiling point lower than 100° C., since solvent removal can be easily performed.

Examples thereof include toluene, xylene, benzene, carbon tetrachloride, methylene chloride, 1,2-dichloroethane, 1,1,2-trichloroethane, trichloroethylene, chloroform, monochlorobenzene, dichloroethylidene, methyl acetate, ethyl acetate, methyl ethyl ketone and methyl isobutyl ketone. These solvents may be used alone or in combination. Among them, aromatic solvents (e.g., toluene and xylene); and halogenated hydrocarbons (e.g., methylene chloride, 1,2-dichloroethane, chloroform and carbon tetrachloride) are preferred.

The solvent is generally used in an amount of 0 parts by mass to 300 parts by mass, preferably 0 parts by mass to 100 parts by mass, more preferably 25 parts by mass to 70 parts by mass, per 100 parts by mass of the prepolymer (A). The solvent used is removed with heating under normal or reduced pressure from the reaction mixture obtained after completion of the elongation and/or crosslinking reaction.

The time required for the elongation and/or crosslinking reaction is determined based on, for example, reactivity depending on a combination of the isocyanate group of the prepolymer (A) and the amine (B), but is generally 10 min to 40 hours, preferably 2 hours to 24 hours.

The reaction temperature is generally 0° C. to 150° C., preferably 40° C. to 98° C.

If necessary, a known catalyst may be used. Specific examples thereof include dibutyltinlaurate and dioctyltinlaurate.

Examples of the method for removing the organic solvent from the granulated particles include a method in which the entire reaction system is gradually increased in temperature to completely evaporate the organic solvent contained in the liquid droplets; and a method in which the granulated particles are sprayed in a dry atmosphere to completely remove and evaporate the water-insoluble organic solvent contained in the liquid droplets and the aqueous dispersing agent. The dry atmosphere in which the granulated particles are sprayed generally uses heated gas (e.g., air, nitrogen, carbon dioxide and combustion gas), especially, gas flow heated to a temperature equal to or higher than the highest boiling point of the solvents used. By performing the treatment even in a short time using, for example, a spray dryer, a belt dryer or a rotary kiln, the resultant product has satisfactory quality.

### <Washing and Drying Step>

A step of washing and drying toner particles dispersed in the aqueous medium can be performed by known techniques. Specifically, the dispersion liquid is separated into solid and liquid using, for example, a centrifugal separator or a filter press. The obtained toner cake is re-dispersed in ion exchange water and, if necessary, the resultant dispersion is adjusted in pH with an acid or alkali, followed by separating into solid and liquid. A series of the above treatments are repeated several times to remove the impurities and the surfactant. Next, the washed product is dried with, for example, an gas flow dryer, a circulation dryer, a reduce-pressure dryer or a vibration fluidization dryer, to thereby obtain a toner base. Here, unwanted fine toner particles may be removed from the toner base through centrifugal separation. Alternatively, the toner base after drying may be classified with a known classifier so as to have an intended particle size distribution.

### [Addition of Mixture Containing Cellulase Ingredient]

The above dispersion slurry preferably contains a mixture containing cellulase ingredients.

The dispersion slurry, which contains toner particles in the aqueous medium after removal of the organic solvent from the mixture of the organic phase dispersion liquid and the aqueous medium, contains cellulose ingredients to be contained in the aqueous medium for thickening. When the dispersion slurry contains a mixture containing cellulase ingredients, the cellulase ingredients decompose the cellulose ingredients, which is preferred from the viewpoints of charging stability over time and suppression of filming on a photoconductor.

Desired effects can be obtained when the mixture containing cellulase ingredients is directly added to the toner particle dispersion liquid before the washing step.

The amount of the mixture containing cellulase ingredients in the dispersion slurry is preferably 30 ppm by mass to 200 ppm by mass, preferably 40 ppm by mass to 150 ppm by mass, relative to the mass of the dispersion slurry. The viscosity of the dispersion slurry after the addition of the mixture containing cellulase ingredients is preferably 6 mPa·s or less, more preferably 3 mPa·s or less, from the viewpoint of successfully performing the subsequent steps. When the amount of the mixture containing cellulase ingredients is more than 200 ppm by mass, sodium carboxymethyl cellulose on the toner surfaces is rapidly decomposed, making it easier to form micelles on the toner surfaces. When the micelles are formed on the toner surfaces, filtration performance in the washing step is considerably degraded. When the amount of the mixture containing cellulase ingredients is less than 30 ppm by mass, the viscosity of the dispersion slurry does not decrease and as a result the dispersion slurry is not dispersed uniformly, making it difficult to extract the surfactant remaining in the dispersion slurry. When the amount of cellulase is adjusted to fall within the above range, uneven washing performance can be prevented, and the mass of S accounting for the mass of the toner base is easier to control. As a result, it is possible to produce a toner stable in charging properties after mixing with an external additive.

The usable mixture containing cellulase ingredients is not particularly limited. Preferred examples thereof include CELLULIZER ACE, CELLULIZER HT, CELLULIZER CL (these products are of Nagase ChemteX Co., Ltd.); PRIMA FIRST, INDIAGENEWTRAFLEX (these products are of Genencor Kyowa Co. Ltd.); GODO-TCL, GODO-TCD-H3 (these products are of GODO SHUSEI CO., LTD.); super thermostable cellulase (product of Thermostable Enzyme Laboratory, Co., Ltd.); VARIDASE ANC40 (product of DSM Japan, Ltd.); CELLSOFT (product of Novozymes, Japan Ltd.); and ENTIRON CM and BIOHIT (these products are of RAKUTO KASEI INDUSTRIAL CO., LTD.).

When the emulsified or dispersed particles having a broad particle size distribution are subjected to washing and drying treatments as they are, the washed and dried particles may be classified so as to have a desired particle size distribution. Classification is performed by removing very fine particles and coarse particles using, for example, a cyclone, a decanter or a centrifugal separator in the liquid.

Finally, the toner base is mixed with external additives such as fine inorganic particles (including fine inorganic particles treated with hydrophobized silica) and then coarse particles are removed from the resultant mixture using, for example, an ultrasonic sieve, whereby a toner is obtained as a final product.

The polymerization method or the capsule method can be used as another production method. As one example of these production methods, the polymerization method will be outlined.

### <Polymerization Method>

a) Granulating polymerizable monomers and, if necessary, a polymerization initiator, a pigment and wax in an aqueous dispersion medium
b) Classifying particles of the monomer composition so as to have an appropriate particle diameter
c) Polymerizing the classified particles of the monomer composition having a particle diameter within a predetermined range
d) Removing a dispersing agent through an appropriate treatment, filtrating the obtained polymer product, washing with water, drying, to form toner base particles

### (Carrier for Two-Component Developer)

When used as a two-component developer, the toner of the present invention may be used as a mixture with a magnetic carrier. Regarding the ratio between the carrier and the toner in the two-component developer, the amount of the toner is preferably 1 part by mass to 10 parts by mass relative to 100 parts by mass of the carrier. The magnetic carrier may be conventionally known carriers such as iron powder, ferrite powder, magnetite powder and magnetic resin carriers having a particle diameter of about 20 μm to about 200 μm.

The carrier is preferably coated with a coating material. Examples of the coating material include amino resins (e.g., urea-formaldehyde resins, melamine resins, benzoguanamine resins, urea resins, polyamide resins and epoxy resins); polyvinyl or polyvinylidene resins (e.g., acryl resins, polymethyl methacrylate resins, polyacrylonitrile resins, polyvinyl acetate resins, polyvinyl alcohol resins and polyvinyl butyral resins); polystyrene resins (e.g., styrene-acryl copolymer resins); halogenated olefin resins (e.g., polyvinyl chloride); polyester resins (e.g., polyethylene terephthalate resins and polybutylene terephthalate resins); polycarbonate resins, polyethylene resins, polyvinyl fluoride resins, polyvinylidene fluoride resins, polytrifluoroethylene resins, polyhexafluoropropylene resins, copolymers of vinylidene fluoride and acryl monomers, a copolymer of vinylidene fluoride and vinyl fluoride, fluoroterpolymers (e.g., terpolymers formed of tetrafluoroethylene, vinylidene fluoride and a non-fluoride monomer), and silicone resins.

If necessary, electroconductive powder or other materials may be incorporated into the coating resin.

The electroconductive powder used may be, for example, metal powder, carbon black, titanium oxide, tin oxide and zinc oxide.

The electroconductive powder preferably has a volume average particle diameter of 1 μm or smaller. When the volume average particle diameter exceeds 1 μm, it is difficult for the electroconductive powder to be controlled in electrical resistance.

The toner of the present invention may be used also as a magnetic or non-magnetic, one-component toner without using a carrier.

### EXAMPLES

The present invention will next be described in more detail by way of Examples and Comparative Examples. However, the present invention should not be construed as being limited to Examples. Unless otherwise specified, the units “part(s),” “%” and “ppm” in Examples mean “part(s) by mass,” “% by mass” and “ppm by mass.”

### Example 1

### Preparation Example 1

### Preparation of Fine Organic Particle Emulsion

A reaction container equipped with a stirring rod and a thermometer was charged with 683 parts of water, 11 parts of a sodium salt of sulfuric acid ester of methacrylic acid-ethylene oxide adduct (ELEMINOL RS-30, product of Sanyo Chemical Industries, Ltd.), 166 parts of methacrylic acid, 110 parts of butyl acrylate, and 1 part of ammonium persulfate, followed by stirring at 3,800 rpm for 30 min. The temperature of the system was heated to 75° C. and the mixture was allowed to react for 4 hours. Subsequently, 30 parts of a 1% aqueous ammonium persulfate solution was added to the reaction mixture, followed by aging at 75° C. for 6 hours, to thereby prepare an aqueous dispersion liquid [fine particle dispersion liquid 1] of a vinyl resin (a copolymer of methacrylic acid-butyl acrylate-sodium salt of sulfuric acid ester of methacrylic acid ethylene oxide adduct). The thus-prepared [fine particle dispersion liquid 1] was measured for volume average particle diameter with LA-920 (product of Horiba, Ltd.) and was found to have a volume average particle diameter of 110 nm. Part of the [fine particle dispersion liquid 1] was dried to separate resin. The thus-separated resin was found to have a Tg of 58° C. and a mass average molecular weight of 130,000.

### Preparation Example 2

### Preparation of Aqueous Medium>

Water (654 parts), 50 parts of the [fine particle dispersion liquid 1], 168 parts of a 50% aqueous solution of sodium dodecyldiphenyl ether disulfonate (ELEMINOL MON-7, product of Sanyo Chemical Industries Ltd.), 240 parts of a 1% aqueous solution of carboxymethyl cellulose serving as a thickening agent, and 88 parts of ethyl acetate were mixed together and stirred to obtain an opaque white liquid [aqueous phase 1].

### Preparation Example 3

### Synthesis of Low-Molecular-Weight Polyester

A reaction container equipped with a condenser, a stirrer and a nitrogen-introducing tube was charged with 229 parts of bisphenol A ethylene oxide 2 mole adduct, 529 parts of bisphenol A propylene oxide 3 mole adduct, 208 parts of terephthalic acid, 46 parts of adipic acid, and 2 parts of dibutyl tin oxide. The mixture was allowed to react under normal pressure at 230° C. for 7 hours and further react under a reduced pressure of 10 mmHg to 15 mmHg for 5 hours. Then, 44 parts of trimellitic anhydride was added to the reaction container, followed by reaction at 180° C. under normal pressure for 3 hours, to thereby produce [low-molecular-weight polyester 1]. The [low-molecular-weight polyester 1] was found to have a number average molecular weight of 2,300, a mass average molecular weight of 6,700, a Tg of 43° C. and an acid value of 25.

### Preparation Example 4

### Synthesis of Intermediate Polyester>

A reaction container equipped with a condenser, a stirrer and a nitrogen-introducing tube was charged with 682 parts of bisphenol A ethylene oxide 2 mole adduct, 81 parts of bisphenol A propylene oxide 2 mole adduct, 283 parts of terephthalic acid, 22 parts of trimellitic anhydride and 2 parts of dibutyl tin oxide. The resultant mixture was allowed to react under normal pressure at 230° C. for 7 hours and further react at a reduced pressure of 10 mmHg to 15 mmHg for 5 hours, to thereby produce [intermediate polyester 1]. The [intermediate polyester 1] was found to have a number average molecular weight of 2,200, a mass average molecular weight of 9,700, a Tg of 54° C., an acid value of 0.5 and a hydroxyl value of 52.

Next, a reaction container equipped with a condenser, a stirrer and a nitrogen-introducing tube was charged with 410 parts of the [intermediate polyester 1], 89 parts of isophorone diisocyanate and 500 parts of ethyl acetate, followed by reaction at 100° C. for 5 hours, to thereby produce [prepolymer 1]. The amount of free isocyanate contained in [prepolymer 1] was found to be 1.53%.

### Preparation Example 5

### Synthesis of Ketimine

A reaction container equipped with a stirring rod and a thermometer was charged with 170 parts of isophorone diisocyanate and 75 parts of methyl ethyl ketone, followed by reaction at 50° C. for 4.5 hours, to thereby produce [ketimine compound 1]. The amine value of [ketimine compound 1] was found to be 417.

### Preparation Example 6

### Preparation of Masterbatch>

Water (1,200 parts), 540 parts of carbon black (Printex35, product of Evonik Degussa) [DBP oil absorption amount=42 mL/100 mg, pH=9.5] and 1,100 parts of a polyester resin were mixed together with HENSCHEL MIXER (product of NIPPON COKE & ENGINEERING. CO., LTD.). The resultant mixture was kneaded at 130° C. for 1 hour with a two-roller mill, and then rolled, cooled and pulverized with a pulverizer, to thereby produce [masterbatch 1].

### Preparation Example 7

### Preparation of Oil Phase>

A container equipped with a stirring rod and a thermometer was charged with 378 parts of the [low-molecular-weight polyester 1], 100 parts of carnauba wax, and 947 parts of ethyl acetate, and the mixture was heated to 80° C. under stirring. The resultant mixture was maintained at 80° C. for 5 hours and then cooled to 30° C. for 1 hour. Subsequently, 500 parts of the [masterbatch 1] and 500 parts of ethyl acetate were charged into the reaction container, followed by mixing for 1 hour, to thereby prepare [raw material solution 1].

The [raw material solution 1] (1,324 parts) was transferred to a container, and the carbon black and the wax were dispersed with a beads mill (ULTRA VISCOMILL, product of AIMEX CO., Ltd.) under the following conditions: a liquid feeding rate of 1 kg/hr, disc circumferential velocity of 6 m/s, 0.5 mm-zirconia beads packed to 80% by volume, and 3 passes. Next, 1,324 parts of a 65% ethyl acetate solution of the [low-molecular-weight polyester 1] was added thereto, and passed twice with the beads mill under the above conditions, to thereby obtain [pigment/wax dispersion liquid 1]. The solid content concentration of the [pigment/wax dispersion liquid 1] was found to be 50% (130° C., 30 min).

### <Emulsification and Desolvation>

The [pigment/wax dispersion liquid 1] (749 parts), 115 parts of the [prepolymer 1] and 2.9 parts of the [ketimine compound 1] were placed in a container, followed by mixing for 2 min at 5,000 rpm with a TK homomixer (product of PRIMIX Co., Ltd.). Thereafter, 1,200 parts of the [aqueous phase 1] was added to the container, and the resultant mixture was mixed with the TK homomixer at 13,000 rpm for 1 min, to thereby produce [emulsified slurry 1]. Next, the [emulsified slurry 1] was charged into a container equipped with a stirrer and a thermometer, followed by desolvation at 30° C. for 8 hours and aging at 45° C. for 7 hours, to thereby produce [slurry 1].

### <Washing and Drying>

(i): The [slurry 1] was separated into solid and liquid, and then washed with a filter press to obtain [filtration cake 1]. Next, ion exchange water was added to the [filtration cake 1] so that the solid content concentration thereof became 20%, followed by dispersing using a disper. The slurry after the dispersing was found to have an electrical conductivity of 350 μS/cm.
(ii): 10% sodium hydroxide was added to the slurry obtained in (i) above so as to have a pH of 8.5, followed by washing for 30 min.
(iii): 10% hydrochloric acid was added to the slurry obtained in (ii) above so as to have a pH of 5.0, followed by washing for 30 min and filtrating under pressure with a filter press. The filtrate was washed through penetration until its electrical conductivity reached 15 μS/cm, to thereby obtain [filtration cake 2].
(iv): Ion exchange water was added to the [filtration cake 2] so that the solid content concentration thereof became 20%, followed by mixing using a disper. Then, 1% aqueous methanol solution of N,N,N-trimethyl-[3-(4-perfluorononenyloxybenzamide)propyl] ammonium iodide [FUTARGENT 310, product of NEOS COMPANY LTD., fluorine-containing compound (1)] was added to the mixture so that the amount of the charge-controlling agent became 0.10% relative to the solid content thereof, followed by stirring for 30 min, to thereby obtain [toner particles 1].
(v): The [toner particles 1] was separated into solid and liquid with a centrifugal separator, and dried at 40° C. for 24 hours using a reduced-pressure dryer, to thereby obtain [toner base particles 1].

Next, 0.5 parts of hydrophobic silica UFP-35 (product of DENKA DENKI KAGAKU KOGYO KABUSHIKI KAISHA), 0.5 parts of −25 hydrophobic silica H2000 (product of Clariant Japan K.K.) and 0.5 parts of hydrophobic titanium oxide MT1501B (product of TAYCA Co., Ltd.) were added to 100 parts of the [toner base particles 1], followed by mixing using HENSCHEL MIXER. Then, coarse particles were removed using a screen having an opening of 37 μm to thereby obtain [toner 1]. The formulation of the toner is presented in Table 2.

### Example 2

[Toner 2] was obtained in the same manner as in Example 1 except that the charge-controlling agent was changed to N,N, N-triethyl-[3-(4-perfluorononenyloxybenzamide)pentyl]ammonium iodide [fluorine-containing compound (3)]. The formulation of the toner is presented in Table 2.

### Example 3

[Toner 3] was obtained in the same manner as in Example 1 except that the anionic surfactant was changed to sodium dodecylbenzenesulfonate and that the amount of the amine added was adjusted to make particle diameters uniform. The formulation of the toner is presented in Table 2.

### Example 4

[Toner 4] was obtained in the same manner as in Example 1 except that in the washing and drying step, CELLULIZER CL (product of Nagase ChemteX Co., Ltd.) was added to the [slurry 1] at a concentration of 80 ppm, followed by stirring for 10 min with THREE-ONE MOTOR, and 1,000 parts of the resultant slurry was separated into solid and liquid and washed with a filter press to thereby obtain the [filtration cake 1]. The formulation of the toner is presented in Table 2.

### Example 5

[Toner 5] was obtained in the same manner as in Example 1 except that the amount of the fluorine-containing compound was changed to 0.12% relative to the toner base. The formulation of the toner is presented in Table 2.

### Example 6

Water (608 parts), 50 parts of the [fine particle dispersion liquid 1], 216 parts of a 50% aqueous solution of sodium dodecyldiphenyl ether disulfonate (ELEMINOL MON-7, product of Sanyo Chemical Industries Ltd.), 240 parts of a 1% aqueous solution of carboxymethyl cellulose serving as a thickening agent, and 86 parts of ethyl acetate were mixed together and stirred to obtain an opaque white liquid [aqueous phase 2].

[Toner 6] was obtained in the same manner as in Example 1 except that the [aqueous phase 1] was changed to the thus-prepared [aqueous phase 2] and that the amount of the amine added was adjusted to make particle diameters uniform. The formulation of the toner is presented in Table 2.

### Example 7

[Toner 7] was obtained in the same manner as in Example 1 except that the anionic surfactant was changed to sodium lauryl sulfate, that the amount of the amine added was adjusted to make particle diameters uniform, and that the amount of the fluorine-containing compound was changed to 0.08% relative to the toner base. The formulation of the toner is presented in Table 2.

### Example 8

Water (700 parts), 50 parts of the [fine particle dispersion liquid 1], 120 parts of a 50% aqueous solution of sodium dodecyldiphenyl ether disulfonate (ELEMINOL MON-7, product of Sanyo Chemical Industries Ltd.), 240 parts of a 1% aqueous solution of carboxymethyl cellulose serving as a thickening agent, and 90 parts of ethyl acetate were mixed together and stirred to obtain an opaque white liquid [aqueous phase 3].

[Toner 8] was obtained in the same manner as in Example 1 except that the [aqueous phase 1] was changed to the thus-prepared [aqueous phase 3] and that the amount of the amine added was adjusted to make particle diameters uniform. The formulation of the toner is presented in Table 2.

### Example 9

[Toner 9] was obtained in the same manner as in Example 1 except that the amount of the fluorine-containing compound was changed to 0.05% relative to the toner base. The formulation of the toner is presented in Table 2.

### Example 10

[Toner 10] was obtained in the same manner as in Example 1 except that in the washing and drying step, CELLULIZER CL (product of Nagase ChemteX Co., Ltd.) was added to the [slurry 1] at a concentration of 30 ppm, followed by stirring for 10 min with THREE-ONE MOTOR, and 1,000 parts of the resultant slurry was separated into solid and liquid and washed with a filter press to thereby obtain the [filtration cake 1]. The formulation of the toner is presented in Table 2.

### Example 11

[Toner 11] was obtained in the same manner as in Example 1 except that in the washing and drying step, CELLULIZER CL (product of Nagase ChemteX Co., Ltd.) was added to the [slurry 1] at a concentration of 200 ppm, followed by stirring for 10 min with THREE-ONE MOTOR, and 1,000 parts of the resultant slurry was separated into solid and liquid and washed with a filter press to thereby obtain the [filtration cake 1]. The formulation of the toner is presented in Table 2.

### Comparative Example 1

[Toner 12] was obtained in the same manner as in Example 1 except that the amount of the fluorine-containing compound was changed to 0.40% relative to the toner base. The formulation of the toner is presented in Table 2.

### Comparative Example 2

Water (470 parts), 50 parts of the [fine particle dispersion liquid 1], 360 parts of a 50% aqueous solution of sodium dodecyldiphenyl ether disulfonate (ELEMINOL MON-7, product of Sanyo Chemical Industries Ltd.), 240 parts of a 1% aqueous solution of carboxymethyl cellulose serving as a thickening agent, and 81 parts of ethyl acetate were mixed together and stirred to obtain an opaque white liquid [aqueous phase 4].

[Toner 13] was obtained in the same manner as in Example 1 except that the [aqueous phase 1] was changed to the thus-prepared [aqueous phase 4] and that the amount of the amine added was adjusted to make particle diameters uniform. The formulation of the toner is presented in Table 2.

### Comparative Example 3

[Toner 14] was obtained in the same manner as in Example 1 except that the anionic surfactant was changed to sodium polyoxyethylene alkyl ether sulfate and that the amount of the amine added was adjusted to make particle diameters uniform. The formulation of the toner is presented in Table 2.

### Comparative Example 4

[Toner 15] was obtained in the same manner as in Example 1 except that the [toner base particles 1] were obtained without adding the 1% aqueous methanol solution of FUTARGENT 310 to the [filtration cake 2]. The formulation of the toner is presented in Table 2.

### Comparative Example 5

[Toner 16] was obtained in the same manner as in Example 1 except that in the washing and drying step, CELLULIZER CL (product of Nagase ChemteX Co., Ltd.) was added to the [slurry 1] at a concentration of 350 ppm, followed by stirring for 10 min with THREE-ONE MOTOR, and 1,000 parts of the resultant slurry was separated into solid and liquid and the [slurry 1] was washed with a filter press to thereby obtain the [filtration cake 1]. The formulation of the toner is presented in Table 2.

### Comparative Example 6

[Toner 17] was obtained in the same manner as in Example 1 except that the amount of the fluorine-containing compound was changed to 0.04% relative to the toner base. The formulation of the toner is presented in Table 2.

Using a turblar mixer whose container rotates for stirring, 7 parts of each of the toners of Examples and Comparative Examples was uniformly mixed and charged with 100 parts of a carrier produced in the following manner, and a two-component developer was produced and evaluated.

### (Production of Carrier)

The following coating materials were dispersed for 10 min with a stirrer to prepare a coat liquid. The thus-prepared coat liquid and the following core material were charged into a coating apparatus having a rotary bottom disc and a stirring blade in a fluidized bed and performing coating while forming swirl flow, to thereby coat the core material with the coat liquid. The thus-coated products were baked in an electric furnace at 250° C. for 2 hours, to thereby produce ferrite carrier particles having an average particle diameter of 35 μm and coated with a silicone resin so as to have an average thickness of 0.5 μm.

Core material: Mn ferrite particles (mass average particle diameter: 35 μm): 5,000 parts

Coating materials: toluene: 450 parts, silicone resin SR2400: 450 parts (product of Toray Dow Corning Silicone Co., non-volatile content: 50%), aminosilane SH6020 (product of Toray Dow Corning Co., Ltd.): 10 parts, carbon black: 10 parts

### <Evaluation>

Properties evaluated are the following (1) to (5). The results are collectively presented Table 3.

### (1) Charge Rising Property

Each of the toners and the carrier were weighed so that the concentration of the toner became 5%, left to stand still at 20° C. for 1 hour, and stirred and mixed for 10 min in a predetermined environment. The resultant mixture was placed in a measuring cage to which a 500-mesh net had been set, followed by blowing off for 30 sec. The charge quantity Q (−μC) and the mass M (g) of the blown powder were measured to determine a charge amount Q/M (−μC/g).

The charge rising property was calculated from the formula: (Q2/Q1)×100(%), where Q1 is a charge amount when the mixture was stirred and mixed for 10 min and Q2 is a charge amount when the mixture was stirred and mixed for 60 sec.

The greater the value is, the better the charge rising property is. Evaluation criteria are as follows.

### —Evaluation Criteria—

A: The value satisfies the target value.
B: The value was at a practically acceptable level.
C: The value was not at a practically acceptable level.

### (2) Charging Stability Over Time

Using an evaluation machine obtained by modifying and tuning IPSIO Color8100 (product of Ricoh Company, Ltd.) so as to be in an oilless fixing method, each toner was subjected to durability printing test where a chart having an image area rate of 5% was continuously printed on 100,000 sheets, and a change in charge amount was evaluated. The change in charge amount was determined with the blow-off method using 1 g of the developer. Evaluation criteria are as follows.

### —Evaluation Criteria—

A: Change in charge amount was 5 [−μC/g] or less.
B: Change in charge amount was greater than 5 [−μC/g] but 10 [−μC/g] or less.
C: Change in charge amount was greater than 10 [−μC/g].

### (3) SuppRession of Filming on a Photoconductor

First, each of the toners (4% by mass) and the carrier (96% by mass) were mixed together to form a two-component developer. The formed developer was caused to develop images on 50,000 sheets per day using a modified machine of IMAGIO NEO C600 (product of Ricoh Company, Ltd.). The image on the 1st sheet and the image on the 300,000th sheet were evaluation images. As for evaluation conditions, the evaluation machine was set such that the linear velocity was 1,700 mm/sec, the developing gap was 1.26 mm, the doctor blade gap was 1.6 mm, and the reflection-type photosensor function was OFF. The photoconductor, the developing device and the transfer device were controlled so that their actual temperature fell within 30° C. to 48° C.

The filming was judged by visually observing the surface of the photoconductor after the printing of 300,000 sheets, and evaluated according to the following evaluation criteria.

### —Evaluation Criteria—

A: Toner filming did not occur.
B: Toner filming slightly occurred.
C: Toner filming occurred much.

### (4) Fixing Property

Solid toner images with the deposited toner amount of 1.0±0.1 mg/cm² were produced on sheets of a plain paper (TYPE 6200, product, of Ricoh Company, Ltd.) and a thick transfer paper (COPY PAPER (135), product of Ricoh Business Expert Ltd.), while changing the temperature of a fixing belt. The highest fixing temperature at which hot offset did not occur in the plain paper was measured. The lowest fixing temperature was measured with the thick transfer paper. The lowest fixing temperature was defined as the temperature of the fixing belt at which the residual rate of the image density was 70% or more after the obtained fixed image had been rubbed with a pad. The lowest fixing temperature is preferably 140° C. or lower. The measurement results are evaluated according to the following criteria.

—valuation Criteria—
A: The measurement satisfied the target value.
B: The measurement was at a practically acceptable level.
C: The measurement was not at a practically acceptable level.

### (5) Overall Evaluation

In the present invention, in order to provide a toner that is satisfactory in all of charge rising property, charging stability over time, suppression of filming on a photoconductor, and fixing property, overall evaluation was performed on each toner so as to take all the evaluation items into consideration. Specifically, the total point of each toner was calculated and evaluated according to the following evaluation criteria, when “A” is 4 points and “B” is 2 points in each of the evaluation items 1) to 4).

### —Evaluation Criteria—

A: 14 points or more
B: 11 points or more but less than 14 points
C: 8 points or more but less than 11 points
D: The worst rank is present in at least one of the evaluation items.

TABLE 2

| | | Amount of | | | | |
|---|---|---|---|---|---|---|
| | Fluorine-containing | fluorine-containing | | Surfactant | Surfactant | CELLULIZER CL |
| Formulation | compound | compound [%] | Sulfur-containing anionic surfactant | [parts] | [%]* | [ppm] |
| Ex. 1 | Compound (1) | 0.10 | Sodium dodecyldiphenyl ether disulfonate | 168 | 7 | 0 |
| Ex. 2 | Compound (3) | 0.10 | Sodium dodecyldiphenyl ether disulfonate | 168 | 7 | 0 |
| Ex. 3 | Compound (1) | 0.10 | Sodium dodecylbenzene sulfonate | 168 | 7 | 0 |
| Ex. 4 | Compound (1) | 0.10 | Sodium dodecyldiphenyl ether disulfonate | 168 | 7 | 80 |
| Ex. 5 | Compound (1) | 0.12 | Sodium dodecyldiphenyl ether disulfonate | 168 | 7 | 0 |
| Ex. 6 | Compound (1) | 0.10 | Sodium dodecyldiphenyl ether disulfonate | 216 | 9 | 0 |
| Ex. 7 | Compound (1) | 0.08 | Sodium lauryl sulfate | 168 | 7 | 0 |
| Ex. 8 | Compound (1) | 0.10 | Sodium dodecyldiphenyl ether disulfonate | 120 | 6 | 0 |
| Ex. 9 | Compound (1) | 0.05 | Sodium dodecyldiphenyl ether disulfonate | 168 | 7 | 0 |
| Ex. 10 | Compound (1) | 0.10 | Sodium dodecyldiphenyl ether disulfonate | 168 | 7 | 30 |
| Ex. 11 | Compound (1) | 0.10 | Sodium dodecyldiphenyl ether disulfonate | 168 | 7 | 200 |
| Comp. Ex. 1 | Compound (1) | 0.40 | Sodium dodecyldiphenyl ether disulfonate | 168 | 7 | 0 |
| Comp. Ex. 2 | Compound (1) | 0.10 | Sodium dodecyldiphenyl ether disulfonate | 360 | 15 | 0 |
| Comp. Ex. 3 | Compound (1) | 0.10 | Sodium polyoxyethylene alkyl ether sulfate | 168 | 7 | 0 |
| Comp. Ex. 4 | None | 0.00 | Sodium dodecyldiphenyl ether disulfonate | 168 | 7 | 0 |
| Comp. Ex. 5 | Compound (1) | 0.10 | Sodium dodecyldiphenyl ether disulfonate | 168 | 7 | 350 |
| Comp. Ex. 6 | Compound (1) | 0.04 | Sodium dodecyldiphenyl ether disulfonate | 168 | 7 | 0 |

*“Surfactant [%]” means a solid content concentration (% by mass) of the surfactant in the aqueous medium.

TABLE 3

| | | | | Charg- | | | |
|---|---|---|---|---|---|---|---|
| | | | | ing sta- | Sup- | Fix- | Over- |
| | | | Charge | bility | pres- | ing | all |
| | | | rising | over | sion of | prop- | eval- |
| | F [ppm] | S [ppm] | property | time | filming | erty | uation |
| Ex. 1 | 470 | 1,230 | A | B | A | A | A |
| Ex. 2 | 390 | 1,260 | B | B | A | A | B |
| Ex. 3 | 480 | 1,200 | A | B | B | B | C |
| Ex. 4 | 470 | 1,190 | A | A | A | A | A |
| Ex. 5 | 580 | 1,160 | A | A | A | B | A |
| Ex. 6 | 460 | 1,470 | B | B | A | A | B |
| Ex. 7 | 310 | 1,310 | B | B | A | A | B |
| Ex. 8 | 480 | 1,020 | A | A | B | B | B |
| Ex. 9 | 210 | 1,250 | B | B | A | A | B |
| Ex. 10 | 450 | 1,460 | B | B | A | A | B |
| Ex. 11 | 460 | 1,050 | B | A | B | A | B |
| Comp. | 1,050 | 1,260 | A | B | A | C | D |
| Ex. 1 | | | | | | | |
| Comp. | 460 | 2,100 | B | C | A | A | D |
| Ex. 2 | | | | | | | |
| Comp. | 480 | 0 | A | A | C | B | D |
| Ex. 3 | | | | | | | |
| Comp. | 0 | 1,150 | C | B | B | A | D |
| Ex. 4 | | | | | | | |
| Comp. | 460 | 3,400 | B | C | A | A | D |
| Ex. 5 | | | | | | | |
| Comp. | 180 | 1,140 | C | B | B | A | D |
| Ex. 6 | | | | | | | |

As is clear from Table 3, the present invention can provide a toner that is satisfactory in all of charge rising property, charging stability over time, suppression of filming on a photoconductor, and fixing property.

Aspects of the present invention are, for example, as follows.

<1> A black toner for developing a latent electrostatic image, including:

a toner base, which contains a pigment, a binder resin, a releasing agent, a compound containing fluorine, and a compound containing sulfur; and

an external additive,

wherein the toner contains the external additive on a surface of the toner base, and

wherein an amount of the fluorine in the toner base is 200 ppm by mass to 600 ppm by mass as measured by combustion-ion chromatography, and an amount of the sulfur in the toner base is 1,000 ppm by mass to 1,500 ppm by mass as measured by the combustion-ion chromatography.

<2> The black toner according to <1>,

wherein the compound containing sulfur is an anionic surfactant containing sulfur.

<3> The black toner according to <2>,

wherein the anionic surfactant containing sulfur is an alkyl diphenyl ether disulfonic acid salt, an alkylbenzenesulfonic acid salt, sodium lauryl sulfate, or any combination thereof.

<4> The black toner according to any one of <1> to <3>,

wherein the compound containing fluorine is N,N,N-trimethyl-[3-(4-perfluorononenyloxybenzamide)propyl]ammonium iodide, N,N, N-triethyl-[3-(4-perfluorononenyloxybenzamide)pentyl]ammonium iodide, or both thereof.

<5> A method for producing the black toner according to any one of <1> to <4>, including:

dispersing, in an aqueous medium containing a compound containing sulfur, an organic phase dispersion liquid containing a pigment, a binder resin and a releasing agent dispersed in an organic solvent, to thereby prepare a dispersion slurry; and providing a filtration cake obtained from the dispersion slurry with a compound containing fluorine, to thereby prepare a toner base.

<6> The method according to <5>,

wherein the dispersion slurry contains a mixture containing cellulase ingredients.

<7> The method according to <6>,

wherein an amount of the mixture containing cellulase ingredients in the dispersion slurry is 30 ppm by mass to 200 ppm by mass.

<8> The method according to any one of <5> to <7>,

wherein an amount of the compound containing sulfur in the aqueous medium is 4% by mass to 10% by mass.

<9> The method according to any one of <5> to <8>,

wherein an amount of the compound containing fluorine is 0.01% by mass to 0.3% by mass relative to a solid content of the filtration cake.

<10> The method according to any one of <5> to <9>,

wherein the providing the filtration cake with the compound containing fluorine is performed by dispersing the filtration cake in an aqueous alcohol solution containing the compound containing fluorine.

1. A black toner for developing a latent electrostatic image, comprising:
a toner base, which comprises a pigment, a binder resin, a releasing agent, a compound containing fluorine, and a compound containing sulfur; and
an external additive,
wherein the toner comprises the external additive on a surface of the toner base, and
wherein an amount of the fluorine in the toner base is 200 ppm by mass to 600 ppm by mass as measured by combustion-ion chromatography, and an amount of the sulfur in the toner base is 1,000 ppm by mass to 1,500 ppm by mass as measured by the combustion-ion chromatography.

2. The black toner according to claim 1,
wherein the compound containing sulfur is an anionic surfactant containing sulfur.

3. The black toner according to claim 2,
wherein the anionic surfactant containing sulfur is an alkyl diphenyl ether disulfonic acid salt, an alkylbenzenesulfonic acid salt, sodium lauryl sulfate, or any combination thereof.

4. The black toner according to claim 1,
wherein the compound containing fluorine is N,N,N-trimethyl-[3-(4-perfluorononenyloxybenzamide)propyl]ammonium iodide, N,N,N-triethyl-[3-(4-perfluorononenyloxybenzamide)pentyl]ammonium iodide, or both thereof.

5. A method for producing the black toner according to claim 1, comprising:
dispersing, in an aqueous medium comprising a compound containing sulfur, an organic phase dispersion liquid comprising a pigment, a binder resin and a releasing agent dispersed in an organic solvent, to thereby prepare a dispersion slurry; and providing a filtration cake obtained from the dispersion slurry with a compound containing fluorine, to thereby prepare a toner base.

6. The method according to claim 5,
wherein the dispersion slurry comprises a mixture containing cellulase ingredients.

7. The method according to claim 6,
wherein an amount of the mixture containing cellulase ingredients in the dispersion slurry is 30 ppm by mass to 200 ppm by mass.

8. The method according to claim 5,
wherein an amount of the compound containing sulfur in the aqueous medium is 4% by mass to 10% by mass.

9. The method according to claim 5,
wherein an amount of the compound containing fluorine is 0.01% by mass to 0.3% by mass relative to a solid content of the filtration cake.

10. The method according claim 5,
wherein the providing the filtration cake with the compound containing fluorine is performed by dispersing the filtration cake in an aqueous alcohol solution containing the compound containing fluorine.
